(19) United States
(12) Patent Application Publication
(10) Pub. No.: US 2024/0420097 A1
(43) Pub. Date: Dec. 19, 2024

(54) INSTANT VERIFICATION METHOD OF CHECK AND STANDARDIZED BILLS OF EXCHANGE

(71) Applicant: Abdelali BOUKACHABINE, Casablanca (MA)

(72) Inventor: Abdelali BOUKACHABINE, Casablanca (MA)

(21) Appl. No.: 18/705,953

(22) PCT Filed: Jun. 13, 2022
(86) PCT No.: PCT/MA2022/000009

§ 371 Date: Apr. 29, 2024

(30) Foreign Application Priority Data
Oct. 27, 2021 (MA) 54769

(51) Int. Cl. G06Q 20/04; G06Q 20/40; G06V 30/416

(52) U.S. Cl. CPC G06Q 20/042; G06Q 20/4037; G06V 30/416

(57) ABSTRACT

The subject matter of the present invention is a management method for avoiding unpaid cheques and unpaid standard bills of exchange by enabling a vendor who receives a payment by one of these two payment methods to have real-time visibility of their customer's ability to honour their commitment. The invention makes it possible to manage the interaction between a vendor who receives a payment by a cheque or a standard bill of exchange and wishes to check the creditworthiness of their customer, and the drawee bank by means of a processing centre linked to a plurality of banks via secure communication channels. The method also provides vendors, during the commercial transaction, with additional reassurance in deciding whether or not to accept a means of payment from their customers, through the generation of a percentage probability of a payment incident, as a result of payment via a cheque or a standard bill of exchange, occurring, with this probability being calculated on the basis of a predictive scoring model.

### FIELD OF THE INVENTION

The present invention relates to a verification Method for Checks and Standardized Bills of Exchange designed to prevent bounced Checks and unpaid Standardized Bills of Exchange by allowing a beneficiary merchant of a payment by one of these two payment instruments to have real-time visibility on the ability of their customer to honor their commitment. The invention manages the interaction between a beneficiary merchant of a payment by a Checks or a Standardized Bills of Exchange—who are concerned that the funds may not exist to cover the Check or a Standardized Bills of Exchange for the amount written and are seeking to monitor the creditworthiness of their customer—and the drawee's bank using a processing center connected to a plurality of banks via secure communication channels.

### DESCRIPTION OF THE RELATED ART

By the end of 2022, the Check was the second most used payment instrument by value with 1,241 billion dirhams for 31.2 million transactions, representing 28% of the exchanged volumes and 7.5% of the number of transactions. The fact that the banks systematically deliver a free checkbook upon the opening of a new bank account can be identified as the main reason that have made this payment instrument one of the most used by Moroccans in the last decade. Standardized Bills of Exchange, on the other hand, accounted for 1.2% of the number of transactions and 7.9% of the exchanged volumes in 2022.

Furthermore, the Central Registry of Payment Incidents on Checks recorded 559,918 incidents declared in 2022, up 12% compared to the previous year, worth 17.2 billion dirhams. Settlement operations dropped by 6% from 192,894 to 181,156 and their amount fell by 2.8 percent to stand at 4.5 billion dirhams. In addition, 60% of these incidents were due to insufficient funds upon presentation for payment.

Outstanding payments on Standardized Bills of Exchange rose by 13% to 590,953. The regularizations remained almost unchanged at 26,732.

Although there have been various methods involving one or more of the different elements used in the present invention, none to date combines these elements in the unique way that the method, described herein, does to provide instant visibility to merchants who accept Checks or Standardized Bills of Exchange as means of payment. In fact, the present invention allows for an easy and efficient method for instant Check and Standardized Bills of Exchange verification.

One known method for verifying and tracking checks is found in US. Patent 1999/U.S. Pat. No. 5,925,865 A that provides an apparatus for accessing and verifying the status of an account or the like which lies behind a negotiable instrument such as a check, travelers check or money order which solves the problems discussed above. That inventive check verification system minimizes the interaction time required by permitting the merchant to validate an instrument by way of a real time, highly automated process, which can increase transaction security and quickly identify lost or stolen checks, including travelers checks and money orders. Unlike our invention, this method does not provide a degree of assurance through a probability of the occurrence of a Check or Standardized Bill of Exchange payment incident.

Another related method can be found in the patent WO 2009/088272 A1. This method enable a bank customer to check it's balance while sending a PIN1 code via a wired or wireless telephone device, a computer, an automatic teller machine, or a check reader by using the internet, satellite and telephone networks to make sure that the account balance covers the amount of the check issued, and order the blocking of the amount prior to the payment transaction; including his signature and fingerprint. The third party can in turn verify this solvency by using a PIN2 code made available to the drawee. This invention is based on sharing a PIN code by both the customer and the third party, unlike the method described here which does not require any exchange of PIN code either with the customer or with the third person. Moreover, the process described here allows a merchant benefiting from a payment by Check or a Standardized Bill of Exchange to have real-time visibility on the ability of their customer to honor their commitment. Furthermore, this invention, unlike the method described here, does not make it possible to provide a degree of assurance through a probability of the occurrence of a Check or Standardized Bill of Exchange payment incident.

### SUMMARY OF THE INVENTION

The present invention relates to a method designed to prevent bounced Checks and unpaid Standardized Bills of Exchange by allowing a beneficiary merchant of a payment by one of these two payment instruments to have real-time visibility on the ability of their customer to honor their commitment. The invention manages the interaction between a beneficiary merchant of a payment by a Check or a Standardized Bill of Exchange, seeking to monitor the creditworthiness of their customer, and the drawee's bank using a processing center connected to a plurality of banks via secure communication channels. The method also offers merchants, during a sales transaction, additional confidence to support their decision-making whether to accept or decline a payment by a Check or a Standardized Bill of Exchange provided by their customers, while generating a probability of a bounced Check or unpaid Standardized Bills of Exchange occurring calculated based on a predictive scoring model.

### BRIEF DESCRIPTION OF THE DRAWING

The invention may take physical form in certain parts and arrangement of parts, a preferred embodiment of Which Will be described in detail in the specification and illustrated in the accompanying drawing which forms a part hereof and wherein:

FIG. 1: illustrates a personal Check or a Standardized Bill of Exchange containing a CMC7 track used with the present invention;

FIG. 2: illustrates the interactions between various components of the method;

FIG. 3: illustrates the data shared between the processing center server (sending mobile device) and the drawee's bank server (receiving mobile device).

FIG. 4: illustrates a flow chart which describes the operation of the method in FIG. 2

FIG. 5: is a chart illustrating how each type of data, grouped into categories, is weighted

FIG. 6: is a table illustrating the score algorithm for one type of data, including various time-based attributes, which can be aggregated and weighted across categories to enable calculating the overall predictive score.

### DETAILED DESCRIPTION OF THE PREFERRED EMBODIMENT

The invention relates to a management method aimed at combating unpaid checks and unpaid Standardized Bills of Exchange by providing a merchant beneficiary of a payment by Check or by a Standardized Bill of Exchange with real-time visibility on their customer's ability to honor their commitment.

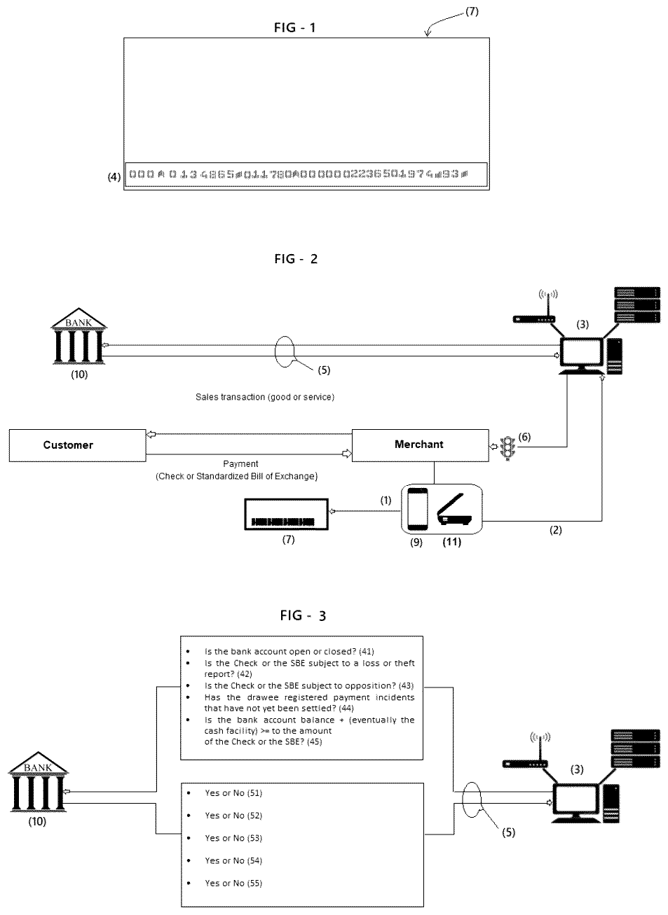

Referring to FIG. 1, a Check or a Standardized Bill of Exchange 7 is depicted with a CMC7 track (Magnetic Ink Character Recognition) 4 printed on the face of the Check or the Standardized Bill of Exchange 7. The CMC7 track 4 is located at the bottom of the Check 7. However, the CMC7 track 4 can be located elsewhere on the Standardized Bill of Exchange 7, e.g., at the bottom left of the Standardized Bill of Exchange. Although not shown in FIG. 1, the present invention can also be used with a Letter Check printed by certain large companies and whose serial number is reserved and communicated directly to these large companies by their banks. Although FIG. 1 illustrates a standard personal Check, the present invention also works with Corporate Checks.

Therefore, it will be understood that the invention described is not limited to the use of personal Checks. Any reference to a Check will include personal Checks, Corporate Checks, and Letter Checks printed by certain large companies, as well as Standardized Bills of Exchange.

The CMC7 track 4 contains information about the account number and the Check number or the Standardized Bill of Exchange 7. The CMC7 track 4 is a digital coding system with seven sticks made with a magnetic ink.

Referring to FIG. 2, a mobile phone 9 is used to read the CMC7 track 4 on the Check or the Standardized Bill of Exchange 7. A check reader or a scanner 11 connected to a computer can also be used by a merchant to read the CMC7 track 4.

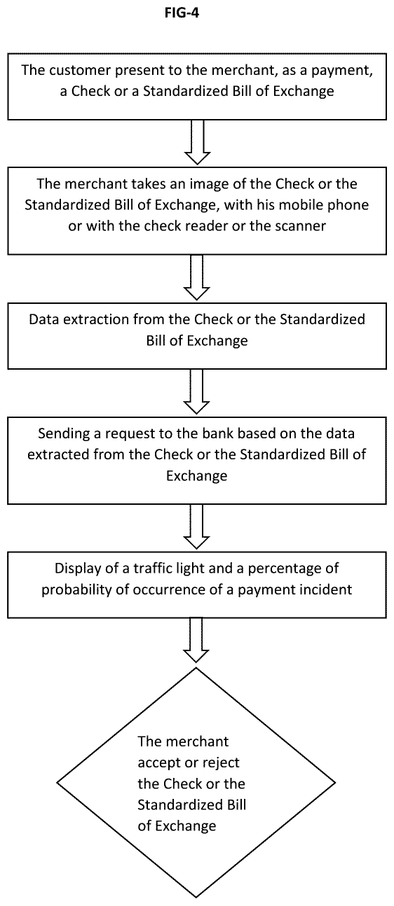

Referring to FIG. 4, the flowchart illustrated describes the operation of the method presented in FIG. 2.

An image recognition software installed on the merchant's mobile phone 9 determines the account number on the Check or the Standardized Bill of Exchange 7 from the CMC7 track 4. The image recognition software subroutine that allows the extraction of the CMC7 track 4 starts once the image, taken by the mobile phone 9 or by the check reader or the scanner 11 connected to a merchant's computer, of a Check or a Standardized Bill of Exchange 7, is stored on the processing center's server 3. Indeed, the image recognition software subroutine is triggered by the detection of the box where the CMC7 track 4 is located, choosing the coordinates of the upper left corner and the lower right corner.

On each of the Checks 7 from the local banks, the CMC7 track 4 is inside this box, with a white background and black numbers and symbols.

Once the detection is completed, the cropped image is transformed into a matrix of 0s and 1s according to the grayscale. Indeed, for each box, the method allows calculating the brightest pixel and the darkest pixel, in order to cancel out the contrast effect, which can be different from one check to another depending on the banks.

For the purposes of this method, a decision value has been defined by the letter A and which corresponds to half the value between the darkest pixel and the brightest pixel. If a pixel is less than A, the pixel becomes 0, if it is greater than 1.

Once the matching is completed, the method allows having a matrix of 0s and 1s, which will be called Matrix01, where 1 represents black and 0 represents white. In this way, it is much easier to manage the numbers.

Bank Checks issued by Moroccan banks have either 33 or 34 digits, which constitute one of the parameters processed during this method. Analysis of the different Matrix01 obtained shows that the height and width of the numbers are always the same because it is the same font that is used.

The method thus uses two functions that allow detecting the numbers.

The first function removes the full left columns of zeros from a given Matrix01.

The second function removes the bottom rows full of zeros from a given Matrix01.

Thus, the first function is used with a Matrix01 to ensure that the first column is indeed the beginning of the first number and to determine the width of each number. Then, the first function is used again with a new Matrix01 with the columns containing the first number and only this number from the “Mother” Matrix01. The second function is then applied by the method to this same matrix, which ensures that the number is always aligned with the bottom left corner. And since the height of a number is already determined, the model removes the rows that will not be used.

This step is concluded by extracting the first Matrix01 corresponding to the first matrix of numbers and framed from the “Mother” Matrix01. Thus, the method repeats this process as many times as the number of numbers.

Once a number is extracted, the method allows converting it into a list of 0s and 1s. Indeed, each bank check will give as many vectors as there are numbers on the CMC7 track 4.

The method has thus been able to finish extracting several vectors representing the numbers, and subsequently, it creates labeled data, for the classification of each vector to determine exactly the CMC7 track 4 from the image automatically transmitted to the processing center's server 3. FIG. 3 illustrates an alternative embodiment of the system depicted in FIG. 2. In this embodiment, the processing center's server 3 is directly connected to the bank 10 using a data link 5. The data link 5 allows bidirectional data transfers between the processing center's server 3 and the bank 10. The data link 5 can be a conventional mobile telephone line. A software routine on the processing center's server 3 uses a lookup table to determine how to contact the bank 10. The lookup table contains bank codes and the corresponding coordinates for each bank. The contact information includes the necessary data and notably the security token to connect and communicate with the bank 10.

The functions executed by the present invention occur in real-time. Real-time is defined as the waiting time of a customer at the point of sale. This waiting time can vary depending on the type of sales transaction offered by the merchant.

Initially, a customer presents a Check or a Standardized Bill of Exchange 7 to the merchant. The merchant takes, with his mobile phone 9 or with the check reader or the scanner 11 connected to a computer, an image of the Check or the Standardized Bill of Exchange 7. The image of the Check or the Standardized Bill of Exchange 7 is then stored on the processing center's server 3. An image recognition software sub-routine installed on the processing center's server 3 determines the account number and the Check number or the Standardized Bill of Exchange 7 from the information contained in the CMC7 track 4 as well as the amount.

Then, the processing center's server 3 contacts the bank 10 via a data link 5 allowing access to a data service provided by the bank 10 securely. The processing center 3 determines which bank to call based on the bank code that is part of the account number extracted from the CMC7 track 4. The processing center's server 3 then calls the appropriate bank 10, allowing the processing center 3 to transmit the account number and the number of the Check or the Standardized Bill of Exchange 7 to the appropriate bank as well as the amount.

Based on the following queries transmitted by the processing center's server 3 (sending mobile device) to the bank 10 server (receiving mobile device):

| | |
|---|---|
| → | Is the bank account open or closed? (41) |
| → | Is the Check or the Standardized Bill of Exchange 7 taken in the |
| | image subject to a loss or theft report? (42) |
| → | Is the Check or the Standardized Bill of Exchange 7 taken in the |
| | image subject to opposition? (43) |
| → | Has the drawee registered incidents of unpaid Checks or |
| | Standardized Bills of Exchange that have not yet been settled? (44) |
| → | Is the bank account balance + (eventually the cash facility) |
| | greater than or equal to the amount of the Check or the |
| | Standardized Bill of Exchange 7? (45) |

The bank 10 verifies the account status and sends back the answers to the processing center's server 3 via the data link 5. The responses transmitted by the bank 10 server (receiving mobile device) to the processing center's server 3 (sending mobile device) are as follows:

| | |
|---|---|
| → | Bank 10 response: Yes or No (51) |
| → | Bank 10 response: Yes or No (52) |
| → | Bank 10 response: Yes or No (53) |
| → | Bank 10 response: Yes or No (54) |
| → | Bank 10 response: Yes or No (55). |

The responses transmitted by the drawee bank server to the processing center's server 3 are translated according to a precise combination into a traffic light 6 displaying the three colors: Red, Orange, Green and are displayed on the mobile phone 9 or on the merchant's computer to which the check reader or the scanner 11 is connected, with a detailed description for each of the colors.

The traffic light 6 will be accompanied by a percentage P of probability of occurrence of an unpaid Check or Standardized Bill of Exchange 7 generated by the predictive scoring model described in the present invention. The predictive model can be trained using a historical dataset of incidents of unpaid Checks and Standardized Bills of Exchange 7.

Initially, the data collected concerns values for each of the plurality of variables used by the predictive scoring model to generate a percentage of probability of occurrence of an unpaid Check or Standardized Bill of Exchange 7.

Predictive scoring related to a percentage P of the probability of occurrence of an unpaid Check or Standardized Bill of Exchange 7 is generally calculated from several different data. This data can be grouped into five categories:
History of incidents of unpaid Checks and Standardized Bills of Exchange 7.
Availability or not of funds in the drawee's bank account.
Amount of the Check or Standardized Bill of Exchange 7 belongs to one of the six ranges of incident payment identified by the Central Bank.
Business sector of the beneficiary of the Check or Standardized Bill of Exchange 7.
Monthly seasonality of incidents of unpaid Checks and Standardized Bills of Exchange 7.

FIG. 5 is an illustration of the percentages reflecting the relative contribution CR of each category in the calculation of the predictive score relative to the probability of occurrence of an unpaid Check or Standardized Bill of Exchange 7.

With certain predictive scoring models, the points of each of the categories can be aggregated to achieve an overall predictive score.

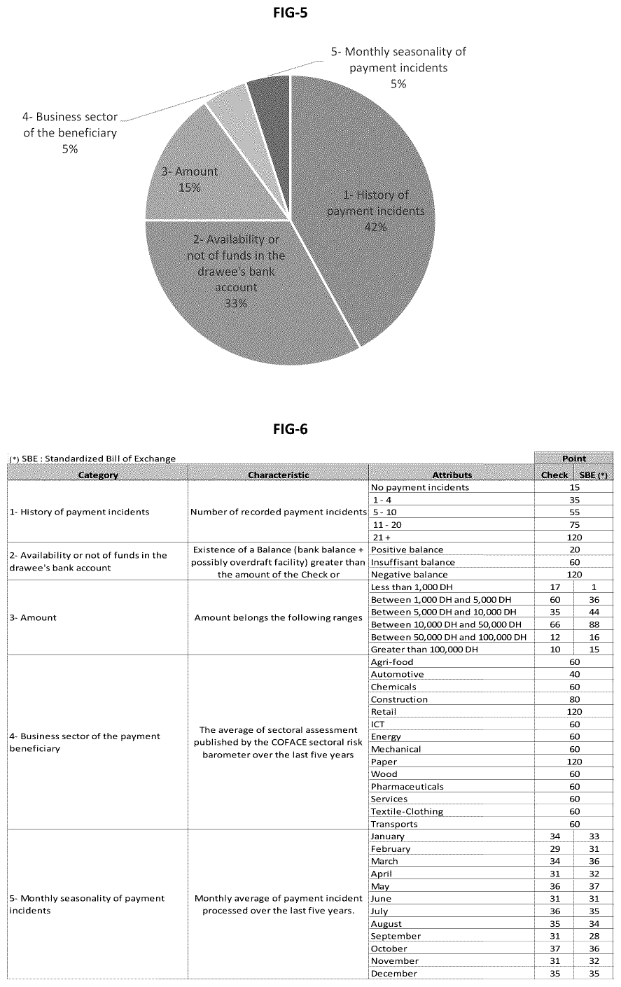

Referring to the table in FIG. 6, each of the five categories can have one or more temporal attributes that are used to generate points that can be, in turn, aggregated and weighted across all categories to give rise to an overall predictive score.

For the history of incidents of unpaid Checks or Standardized Bills of Exchange 7, the number of points can be based on the number of recorded incidents of unpaid Checks or Standardized Bills of Exchange 7. The weighting of the number of recorded incidents of unpaid Checks or Standardized Bills of Exchange 7 P1 is calculated by dividing the number of points of the attribute of a Check or a Standardized Bill of Exchange 7 by the total number of points. As an illustration, if the attribute of the number of recorded incidents of unpaid payments is between 5-10, the weighting P1 is equal to P1=18.33%.

For the availability of funds in the drawee's bank account, the number of points can be based on the existence of a balance greater than the amount of the Check or the Standardized Bill of Exchange 7. The weighting of the existence of a balance P2 (bank balance+possibly a cash facility) greater than the amount of the Check or the Standardized Bill of Exchange 7 is calculated by dividing the number of points of the attribute of a Check or a Standardized Bill of Exchange 7 by the total number of points. As an illustration, if the attribute of the existence of a balance greater than the amount of a Check is equal to a negative balance, the weighting P2 is equal to P2=60%.

For the amount, the number of points can be based on the belonging of the amount of the Check or the Standardized Bill of Exchange 7 to one of the six ranges of amounts of unpaid incidents declared to the CIP. The weighting of the belonging of the amount P3 of the Check or the Standardized Bill of Exchange 7 to one of the six ranges of amounts of unpaid incidents declared to the CIP is calculated by dividing the number of points of the attribute of a Check or a Standardized Bill of Exchange 7 by the total number of points. As an illustration, if the attribute of the belonging of the amount of a Check to one of the six ranges of amounts of unpaid incidents declared to the CIP is between 10,000 DH and 50,000 DH, the weighting P3 is equal to P3=33%.

For the business sector of the beneficiary of the Check or the Standardized Bill of Exchange 7, the number of points can be based on the average of sectoral evaluations published by the COFACE sectoral risk barometer over the last five years. The weighting of the average sectoral evaluations P4 published by the COFACE sectoral risk barometer over the last five years is calculated by dividing the number of points of the attribute of a business sector by the total number of points. As an illustration, if the attribute of the business sector is equal to Distribution, the weighting P4 is equal to P4=12.5%.

For the seasonality of incidents of unpaid payments, the number of points can be based on the monthly average of declarations of unpaid incidents processed by the CIP over the last five years. The weighting of the monthly average of declarations of unpaid incidents P5 processed by the CIP over the last five years is calculated by dividing the number of points of the attribute of a business sector by the total number of points. As an illustration, if the attribute of the seasonality of unpaid incidents of a Check is equal to July, the weighting P5 is equal to P5=9%.

Thus, the percentage P of probability of occurrence of an unpaid Check or Standardized Bill of Exchange 7 generated by the predictive scoring model is calculated as follows:

$$P = CR 1 * P 1 + CR 2 * P 2 + CR 3 * P 3 + CR 4 * P 4 + CR 5 * P 5$$

For example, following the scan of a Check 7 and based on a query transmitted by the processing center's server 3 to the drawee bank 10 server, the bank 10 verifies the account status and sends back the answers to the processing center's server 3 via the data link 5. The responses transmitted by the drawee bank 10 server to the processing center's server 3 and the information extracted from the Check highlight the following attributes:

The percentage P of probability of occurrence of an unpaid Check generated by the predictive scoring model is as follows:

$$P = 42 \% * 18.33 \% + 33 \% * 60 \% + 15 \% * 33 \% + 5 \% * 12.5 \% + 5 \% * 9 \%$$

$$P = 33.53 \%$$

With the traffic light 6 and the percentage P of probability of occurrence of an unpaid Check, the merchant can then decide to accept or not the Check or the Standardized Bill of Exchange 7. If the merchant decides to accept the Check or the Standardized Bill of Exchange 7, the sales transacn is concluded. If the merchant decides not to accept the Check or the Standardized Bill of Exchange 7, the sales transaction can be canceled or the customer can propose another method of payment. In case of loss or theft of the Check or the Standardized Bill of Exchange 7, the merchant may be invited to contact the bank 10 to inform them that this lost or stolen means of payment has been presented at this merchant. In one embodiment of this invention, the availability of funds in the customer's bank account is not affected by the verification process. However, the invention can also be implemented with the aim of blocking the amount of the Check or the Standardized Bill of Exchange 7 in the customer's bank account at the time of the sales transaction.

The bank account information extracted from the CMC7 4 track of the Check or the Standardized Bill of Exchange 7 of the customer and those received from the customer's bank 10 can optionally be recorded and used with a program executed for a cashing of Checks and Standardized Bills of Exchange 7 to the merchant's bank for payment and clearing. Using the previously recorded customer's bank account information reduces the time required for processing Checks or Standardized Bills of Exchange 7 at the end of the day for the merchant. Other transaction details such as the item or service purchased, the quantity, and the price can be recorded for future reporting. Although a particular embodiment of the invention has been described in detail for illustrative purposes, it will be understood that variations or modifications of the method are within the scope of the present invention.

What is claimed is:

1- A computer-implemented method for automatically displaying on the screen of a mobile phone or computer a percentage probability of occurrence of a payment incident, by a predictive scoring model based on several characteristics extracted from a Check or a Standardized Bill of Exchange, which are subject of instantaneous communication between the server of the processing center and the server of the bank, and thus allowing a merchant to decide whether or not to accept a Check or a Standardized Bill of Exchange during a sales transaction depending on the color of the light traffic associated with the probability percentage calculated by the model, and including the following steps:
Display on the screen of a mobile phone or computer user-readable instructions for capturing an image of a Check or Standardized Bill of Exchange with a mobile phone or with a reader check or scanner connected to a computer.
Extract the following parameters using an image recognition algorithm:
The bank account number
The number of the Check or a Standardized Bill of Exchange
The amount of the Check or a Standardized Bill of Exchange
then store these extracted parameters on the processing center server.
Send from the processing center server the extracted parameters from a Check or Standardized Bill of Exchange to the bank server using an algorithm based on a lookup table containing bank codes and contact information, allowing secure communication to be automatically established with the appropriate bank.
Receive as response from the bank server, and retain, the following new parameters, which characterize the solvency of the issuer of a Check or a Standardized Bill of Exchange:
a—Is the bank account open or closed?
b—Is the Check or the Standardized Bill of Exchange subject to a loss or theft report?
c—Is the Check or the Standardized Bill of Exchange subject to opposition?
d—Has the drawee registered incidents of unpaid Checks or Standardized Bills of Exchange that have not yet been settled?
e—Is the bank account balance+ (eventually the cash facility) greater than or equal to the amount of the Check or the Standardized Bill of Exchange?
Automatically calculate by a predictive scoring model, once the answers for the three new parameters above are as follows:

| | |
|---|---|
| a- | YES |
| b- | NON |
| c- | NON |

a percentage probability of occurrence of a payment incident based on the parameters listed below, recorded in the processing center server database, and for which a relative contribution is attributed to each parameter:
History of incidents of unpaid Checks and Standardized Bills of Exchange.
Availability or not of funds in the drawee's bank account
Amount of the Check or Standardized Bill of Exchange belongs to one of the six ranges of incident payment identified by the Central Bank.
Business sector of the beneficiary of the Check or Standardized Bill of Exchange.
Monthly seasonality of incidents of unpaid Checks and Standardized Bills of Exchange.
Display on the screen of a mobile phone or computer user-readable instructions related to the percentage probability of occurrence of a payment incident, automatically calculated by a predictive scoring model, associated with traffic light displaying one of the three colors: Red, Orange, Green depending on the percentage of probability of occurrence calculated, to thus enable a merchant to decide whether or not to accept a Check or a Standardized Bill of Exchange during a sales transaction based on traffic light color.
Store the percentage probability of occurrence of a payment incident, calculated automatically by a predictive scoring model in a database on the processing center server together with the parameters extracted from a Check or Payment Letter Standardized Exchange and the new parameters received from the bank's server and which characterize the solvency of the issuer of a Check or a Standardized Bill of Exchange.

2- A method of claim 1, wherein the method further is characterized in that the processing center comprises an image recognition algorithm allowing to extract the following parameters: the bank account number; The Number of a Check or the Number of a Standardized Bill of Exchange; The Amount of a Check or on a Standardized Bill of Exchange and to keep these extracted parameters for use in future processing relating to the sales transaction for which payment was made using a Check or a Bill of Exchange Standardized.

3- A method of claim 1, wherein the method further is characterized in that an algorithm, based on a lookup table containing the codes of the banks and contact information, allowing to automatically establish secure communication between the server of the center of processing and the server of the bank of the issuer of a Check or a Standardized Bill of Exchange.

4- A method of claim 1, wherein the method further is characterized in that a predictive rating model based on both the new parameters, received from the bank's server, which characterize the solvency of the issuer of a Check or Letter of Standardized Exchange and on the other parameters recorded in the processing center server database and for which a relative contribution is attributed to each parameter, automatically calculates a percentage probability of occurrence of a payment incident.

5- A method of claim 1, wherein the method further is characterized in that an algorithm makes it possible to display, on the screen of a mobile telephone or a computer, instructions readable by the user, a percentage probability of occurrence of a payment incident of a Check or a Standardized Bill of Exchange associated with light traffic presenting one of the three colors: Red, Orange, Green depending on the percentage of probability of occurrence of a calculated payment incident automatically by a predictive scoring model to allow a merchant to decide whether or not to accept a Check or a Standardized Bill of Exchange during a commercial transaction based on the color of light traffic.
